(19) United States
(12) Patent Application Publication
(10) Pub. No.: US 2012/0075179 A1
(43) Pub. Date: Mar. 29, 2012

(54) ELECTRONIC DEVICE

(75) Inventor: Tsuyoshi HASEGAWA, Osaka (JP)

(73) Assignee: SANYO ELECTRIC CO., LTD., Osaka (JP)

(21) Appl. No.: 13/307,859

(22) Filed: Nov. 30, 2011

Related U.S. Application Data
(63) Continuation-in-part of application No. PCT/JP10/67057, filed on Sep. 30, 2010.

(30) Foreign Application Priority Data
Oct. 1, 2009 (JP) 2009-229750

(51) Int. Cl. G09G 5/00

(52) U.S. Cl. 345/156

(57) ABSTRACT

The electronic device has a displaying unit which displays information; an operating unit which accepts a contactless oberation by a user; a detecting unit which detects whether or not on object exists inside the area where the contact less operation is capable, and a lighting unit which lights when the detecting unit detected the existence of the object.

### CROSS-REFERENCE TO RELATED APPLICATIONS

This application is a continuation-in-part application of Patent Cooperation Treaty Patent Application No. PCT JP 2010/062057 (filed on Sep. 30, 2010), which claims priority from Japanese patent application JP 2009-229750 (filed on Oct. 1, 2009). All of which are hereby incorporated by reference herein.

### BACKGROUND OF THE INVENTION

1. Field of the Invention

The present invention relates to the electric device capable of user's operation by contactiess sensing.

2. Description of the Related Art

In recent years, the electric device having a touch panel has appeared. In such device, a motion of a user's finger is detected based on the variation of electric capacity. Conventionally, those touch panels were contacting type inputting device, however, recently a contactless type inputting device is appearing.

In the contacting type device, user can easily recognize that he or she has actually made operation to the device, because the operation is made when the user actually touch the button or touch panel. On the other hand, in the contactless type device, it is sometimes difficult for user to recognize whether or not he (or she) actually made operation to the device.

### SUMMARY OF THE INVENTION

An electronic device according to the present invention has a displaying unit which displays information; an operating unit which accepts a contactless oTgeration by a user; a detecting unit which detects whether or not an Object exists inside the area where the cohtactiess operation is capable, and a lighting unit which lights when the detecting unit detected the existence of the object.

### BRIEF DESCRIPTION OF THE DRAWINGS

FIG. 1 is a perspective diagram of the television receiver 1.

FIG. 2 is a side view of the television receiver 1.

FIG. 3 is a block diagram of the television receiver

FIG. 4 is a figure showing the configuration of the contactless operating unit 20.

FIG. 5 is a figure showing the detection area 31 of the contactless operating unit 20.

### DETAILED DESCRIPTION OF PREFERRED EMBODIMENTS

A television receiver 1 according Lo an embodiment of the present invention is described below.

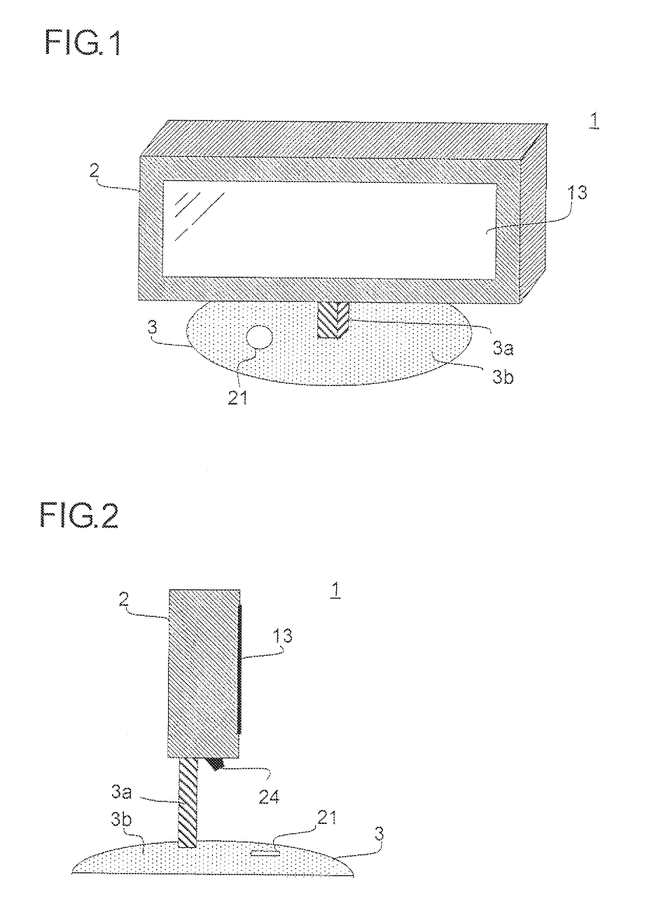

FIG. 1 and FIG. 2 show the exterior views of the television receiver 1. FIG. 1 is its perspective view and FIG. 2 is its side view.

As shown in these figures, the television, receiver 1 has a display 13, a casing 2, a stand 3, a touch panel 21, and LED 24.

The display 13 typically has LCD (Liquid Crystal. Display) panels or PDP (Plasma Display Panel), for example, and displays an image. The casing 2 stores the display 13. The stand 3 functions as a supporting member for the display 13 and the housing 2. The stand 3 comprises a supporting portion 3a and a base portion 3d. The touch panel 21 is arranged under the housing 2, and above the base portion 3b. The LED 24 is arranged under the casing 2.

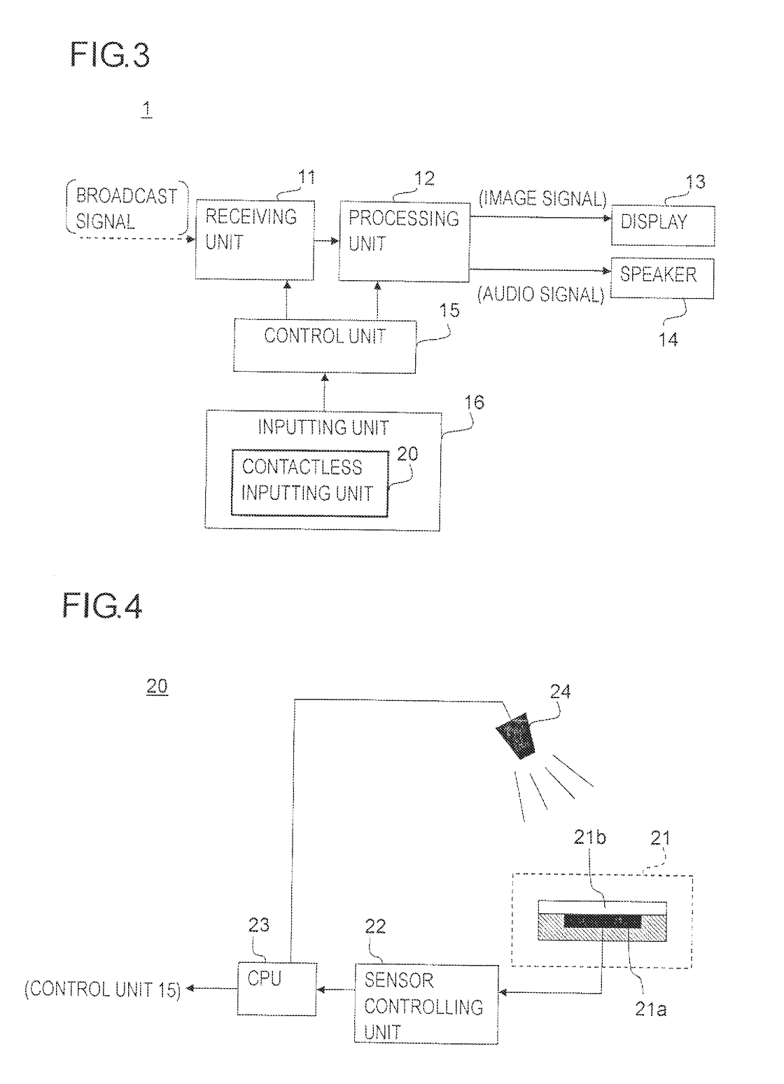

FIG. 3 is a block diagram of the television receiver 1. As shown in FIG. 3, the receiver 1 has a receiving unit 11, a processing unit 12, the display 13, a speaker 14, a control unit 15, and inputting unit 16.

The receiving unit 11 has a tuner which tunes the signal inputted from an antenna for selecting the channel of television broadcasting. The tuning in the tuner is achieved by an instruction from the control unit 15, based on an input from the inputting unit 16.

The processing unit 12 demodulates the signal tuned by the unit 11, and divides the demodulated signal into an image signal and an audio signal. Then, each of the divided signals is decoded. The decoded image signal is transmitted to the display 13, and the decoded audio signal is transmitted to the speaker 14.

The control unit 15 is constituted by CPU (Central Processing Unit) or DSP (Digital Signal Processor).

The inputting unit 16 comprises a button switch equipped on the casing 2 or a remote controller.

Further, the inputting unit 16 includes a contactiess inputting unit 20.

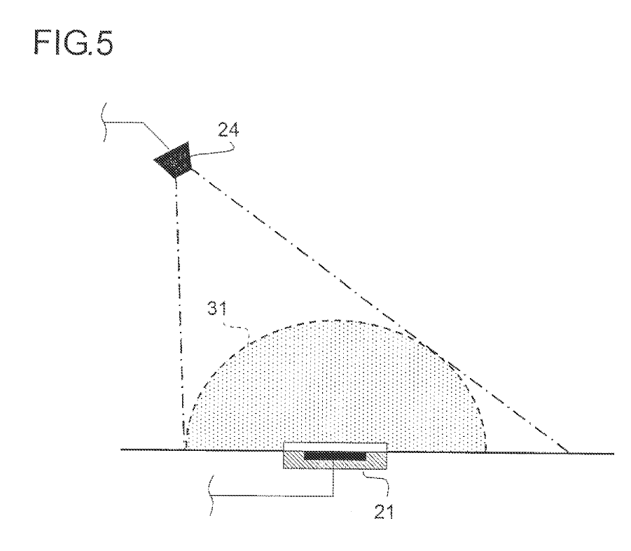

As shown in FIG. 4, the contactiess inputting unit 20 comprises a touch panel 21, a sensor controlling unit 22, CPU 23, and the LED 24.

A touch panel 21 has a structure that the touch pad 21a is covered by a cover 21b. When a user's finger approaches the touch panel 21, the electric capacity varies. The amount the variation becomes large as the finger approaches the touch pad 21a.

The sensor controlling unit 22 detects the variation amount of the electric capacity in a touch panel 21, and transmits the variation amount !information to CPU 23.

When the variation detected by the sensor controlling unit 22 is larger than a predetermined value, the CPU 23 determines that an object (finger) exists near the touch panel 21 (in other words, inside of the detecting area 31 shown in FIG. 5), and transmits this information to the control unit 15.

Further, when the variation detected in the unit 22 is larer than the predetermined value, the CPU 21 outputs a predetermined signal to LED 24.

In detail, the CPU 23 generates the PUN (Pulse Width Modulated) signal according to the variation of the electric capacity, and transmits the generated signal to the LED 24.

Then, LED 24 irradiates the object inside the area 31. Thereby, the user can recognize whether or not he (or she) can melee contactless operation to the touch panel 21.

On the other hand, it the object leaves away from the touch panel 21, the variation of the electric capacity decreases. As a result, it is determined that the object has moved outside the detecting area 31, and the CPU 23 controls LED 24 to turn it off. Thereby, the user can recognize that contactiess input to the touch panel 21 is unavailable.

According to the present embodiment, the user can recognize whether his (or her) operation to the contactless inputting device is available or not

The embodiment of the present invention is described as above. However, the scope of the present invention is not limited, thereto, and the present invention may be implemented by being subjected to various modifications without departing from the gist of the present invention.

1. An electronic device comprising:
a displaying unit which displays information;
an operating unit which. accepts a contactless operation by a user;
a detecting unit which detects whether or not an object exists inside the area where the contactiess operation is capable, and
a lighting unit which lights when the detecting unit detected the existence of the object.
